(19) United States
(12) Patent Application Publication
(10) Pub. No.: US 2016/0350688 A1
(43) Pub. Date: Dec. 1, 2016

(54) Low error rate interface for untrained users based on a method and system for event tracking

(71) Applicant: David Robert Wilkes, Richmond Hill (CA)

(72) Inventor: David Robert Wilkes, Richmond Hill (CA)

(21) Appl. No.: 15/202,969

(22) Filed: Jul. 6, 2016

Related U.S. Application Data
(62) Division of application No. 11/543,236, filed on Oct. 5, 2006.

(51) Int. Cl. G06Q 10/06; G06Q 10/08; G06K 7/10; G06Q 30/06

(52) U.S. Cl. CPC G06Q 10/06312; G06Q 30/0635; G06Q 10/0875; G06K 7/10297; G06K 2007/10504

(57) ABSTRACT

A method of event tracking in a production environment includes storing each of at least one production event identifier in association with a respective plurality of expected production events prior to production. During production, a production event identifier is received from a user interface associated with the production environment to signal occurrence of one of the expected production events. In response to the receiving, it is automatically determined which one of the expected production events has occurred based on previous receipt of the received production event identifier. Event occurrence data relating to the expected production event determined to have occurred is then stored.

### FIELD OF THE INVENTION

The methods and systems disclosed herein relate generally to event tracking, and more particularly to a method and system of event tracking in a production or analogous environment.

### BACKGROUND OF THE INVENTION

It is a challenge for manufacturing companies to track plant operations for the purpose of managing the operations. The advantages available to a manufacturing company that is able to track manufacturing/production cost variances are well-known. For example, a company that tracks cost variances and provides timely reporting on the variances can efficiently manage exceptions that arise by quickly accounting for the exceptions. Corrections can then be made in real-time as deemed appropriate in order to optimize production.

It is known to track production costs by recording the use of raw material and labor inputs for each production lot. Based on the tracking of production costs and use of raw material, production may be optimized in order to minimize the total cost of production. For example, a known technique for production cost tracking is to have production staff record the issue of raw materials to the production area, record the completion of finished goods, and allocate their labor hours to particular production lots.

Real-time manufacturing cost variance tracking is typically only available to medium and large sized businesses due primarily to the costs associated with having such features integrated in Enterprise Resource Planning (ERP) and/or Materials Requirements Planning (MRP) and/or accounting software systems. Installation, training and support for such systems, including Information Technology (IT) and inventory management hardware, typically require an investment of $100,000 or more. Furthermore, a significant IT infrastructure including dedicated personnel and networks is typically required.

ERP and MRP systems are characterized by large numbers of interacting software modules and user interface screens for several dozen distinct functions that integrate for operation of the system. These systems typically provide distinct and complex interfaces for accounting, inventory management, production management, purchasing, and many others.

Because of their complexities, interfaces to existing ERP/MRP systems require that choices be made by plant/production staff in order to select the required functionality, and identify plant events and auxiliary details to the systems via the required interfaces. Prior to introduction and use of the ERP/MRP systems providing these interfaces, there must be a willingness on the part of all company personnel to undertake extensive training. Even after having undertaken extensive training, a high rate of error continues to characterize users' interaction with these systems.

A further difficulty with known accounting systems in small- to mid-size companies in particular, is that they operate typically on a monthly cycle, wherein the current cycle's reports are only available at the conclusion of the cycle. As such, there is a delay between the time at which production cost variations occur, and the time at which management becomes aware of the variations. Management is therefore generally unable to react to and address the variations in real-time, if at all.

It is an object of an aspect of the following to provide a novel method and system for event tracking that obviates or mitigates at least one of the above disadvantages.

### SUMMARY OF THE INVENTION

According to one aspect, there is provided a method of event tracking in a production environment, comprising:

prior to production, storing each of at least one production event identifier in association with a respective plurality of expected production events;

during production, receiving a production event identifier from a user interface associated with the production environment to signal occurrence of one of the expected production events;

in response to the receiving, automatically determining which one of the expected production events has occurred based on previous receipt of the received production event identifier; and

storing event occurrence data relating to the expected production event determined to have occurred.

In an embodiment, the expected production events include delivery of raw material to the plant and raw material issue to the production process, and one or more of the at least one production event identifier comprises a raw material identifier, receipt of which from the user interface signals occurrence of one of delivery and issue of raw material

In an embodiment, the expected production events include finished goods completion and finished goods shipping, and one or more of the at least one production event identifier comprises a finished goods identifier, the receipt of which signals occurrence of one of completion and shipping of finished goods.

According to another aspect, there is provided a method of event tracking, comprising:

storing each of at least one event identifier in association with a respective plurality of expected events;

receiving an event identifier from a user interface to signal occurrence of one of the expected events;

in response to the receiving, determining which one of the expected events has occurred based on previous receipt of the received event identifier; and

on the basis of the determining, storing event occurrence data.

According to yet another aspect, there is provided a system for event tracking in a production environment, comprising:

a storage device;

a first user interface storing in the storage device each of at least one production event identifier in association with a respective plurality of expected production events;

a second user interface associated with the production environment receiving a production event identifier to signal occurrence of one of the expected production events during production; and

a processor, in response to the receiving, automatically determining which one of the expected production events has occurred based on previous receipt of the received production event identifier and storing in the storage device event occurrence data relating to which of the expected production events has been determined to have occurred in the production environment.

According to yet another aspect, there is provided a system for event tracking, comprising:

a storage device;

a first user interface storing each of at least one event identifier in association with a respective plurality of expected events;

a second user interface receiving an event identifier to signal occurrence of one of the expected events; and

a processor, in response to the receiving, determining which one of the expected events has occurred based on previous receipt of the received event identifier and storing in the storage device event occurrence data on the basis of the determining.

According to still another aspect, there is provided a computer readable medium including a computer program for event tracking in a production environment, the computer program comprising:

computer program code storing each of at least one production event identifier in association with a respective plurality of expected production events prior to production;

computer program code receiving a production event identifier from a user interface associated with the production environment during production to signal occurrence of one of the expected production events;

computer program code automatically determining, in response to the receiving, which one of the expected production events has occurred based on previous receipt of the received production event identifier; and

computer program code storing event occurrence data relating to the expected production event determined to have occurred.

According to yet another aspect, there is provided a computer readable medium including a computer program for event tracking, the computer program comprising:

computer program code storing each of at least one event identifier in association with a respective plurality of expected events;

computer program code receiving an event identifier from a user interface to signal occurrence of one of the expected events;

computer program code determining, in response to the receiving, which one of the expected events has occurred based on previous receipt of the received event identifier; and

computer program code storing event occurrence data on the basis of the determining.

According to still another aspect, there is provided a method of event tracking, comprising:

storing each of at least one event identifier in association with a respective plurality of expected events;

receiving an event identifier from a user interface to signal occurrence of one of the expected events;

in response to the receiving, automatically determining which one of the expected events has occurred based on a system state at the time the received event identifier is received from the user interface; and

on the basis of the determining, adjusting the system state.

The method, system and computer program on a computer readable medium disclosed herein provide the significant advantage of enabling real-time event tracking in production or other environments. Furthermore, receiving only event identifier data from the user interface to signal occurrence of an expected event significantly reduces the complexity of the user interface for production staff or other personnel. Because of the simplicity of the user interface provided herein, decision making when operating the user interface is significantly reduced or eliminated. Errors in tracking events are thereby significantly reduced and tracking is far more accurate and illustrative of the operation of the environment.

Particularly useful in the production environment, the event occurrence data is used to prepare an event tracking report. As such, it is possible to track in real-time raw material usage variances and/or gross margin based on predetermined usage standards and/or predetermined price and cost standards. The report may be prepared respecting a preselected production date/time period.

### BRIEF DESCRIPTION OF THE DRAWINGS

Embodiments will now be described more fully with reference to the accompanying drawings, in which:

FIG. 1 is a network topology diagram showing interfaces of a single-client system for event tracking;

FIG. 2 is a network topology diagram showing a multi-client system integrating several single-client interfaces shown in FIG. 1;

FIG. 3 is a flow diagram of a method of event tracking in a production environment;

FIG. 4 is a flow diagram of the receipt and storage of production context data;

FIG. 5 is a flow diagram of the receipt of event tags from a user interface;

FIG. 6 is a flow diagram of the determination and storage of production event occurrence data;

FIG. 7 is a flow diagram of the generation of a materials usage report;

FIG. 8 is a flow diagram of the generation of a gross margin report; and

FIG. 9 is a data flow diagram showing finished goods and raw material event occurrence data and predetermined standards used to calculate the materials usage variance and gross margin reports.

### DETAILED DESCRIPTION OF THE EMBODIMENTS

Described herein is a method, system and a computer readable medium embodying a computer program for event tracking in a production environment. The method includes storing each of at least one production event identifier in association with a respective plurality of expected production events prior to production. During production, a production event identifier is received from a user interface associated with the production environment to signal occurrence of one of the expected production events. In response to the receiving, it is automatically determined which one of the expected production events has occurred based on previous receipt of the received production event identifier. Event occurrence data relating to which of the expected production events has been determined to have occurred in the production environment is then stored.

The method and system may be embodied in a software application including computer executable instructions executed by a processing unit such as a personal computer or other computing system environment. The software application may run as a stand-alone event tracking tool or may be incorporated into other available applications to provide enhanced functionality to those applications. The software application may include program modules including routines, programs, object components, data structures etc. and be embodied as computer readable program code stored on a computer readable medium. The software program may be written in one or more computer languages, such as PHP, Java, C++, database stored procedures, triggers etc., and on one or more platforms. The computer readable medium is any data storage device that can store data, which can thereafter be read by a computer system. Examples of computer readable media include for example read-only memory, random-access memory, CD-ROMs, magnetic tape and optical data storage devices. The computer readable program code can also be distributed over a network including coupled computer systems so that the computer readable program code is stored and executed in a distributed fashion.

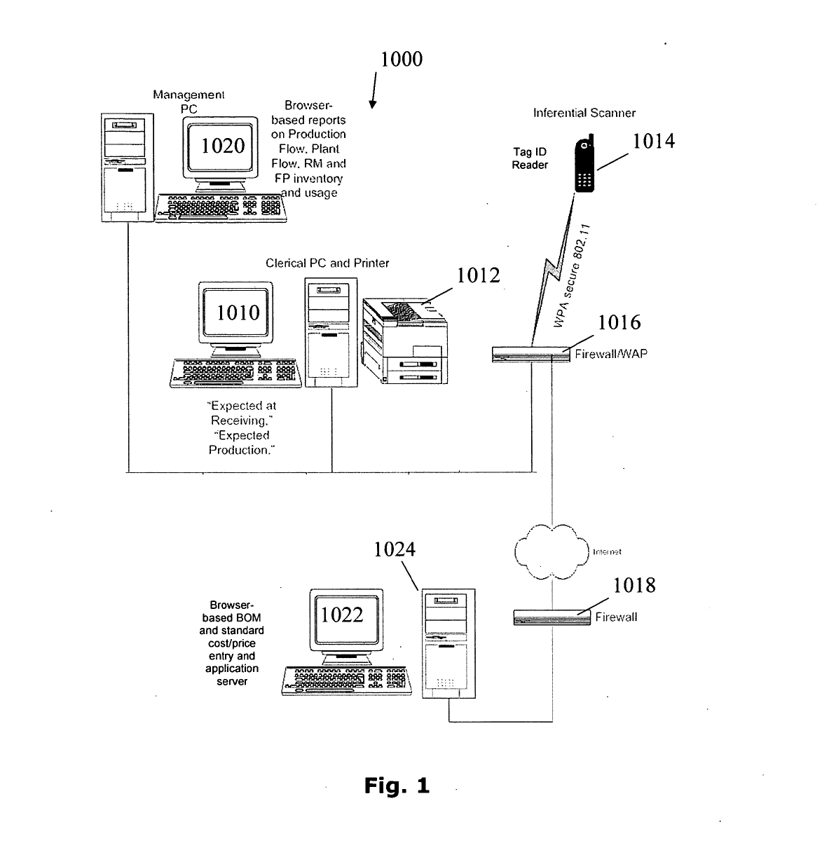

FIG. 1 is a network topology diagram showing interfaces of a single-client system 1000 for event tracking, according to an embodiment. System 1000 comprises a first user interface 1010 for use by clerical staff to enter and provide context data for storage in an event tracking database on a central server 1024. Central server 1024 runs an Apache™ web server with a PHP library, a secure socket layer interface, a relational database for event tracking and PHP programs to generate interfaces and operate on received and stored data. A software application running on the central server 1024 receives the context data and stores expected event data in sequence in association with respective event identifier(s) in the event tracking database. First user interface 1010 also includes a printer 1012 for printing Expected At Receiving and Expected Production Reports having removable barcode tags for affixing to raw materials or finished goods, as will be described. The removable barcode tags incorporate respective ones of raw material identifiers and finished goods identifiers.

A second user interface 1014 is a wireless scanner device (or “inferential scanner”) capable of scanning the unique barcode tag on raw material or finished goods during the production process to obtain an event identifier (raw material identifier or a finished goods identifier), and transmitting the event identifier to central server 1024 in a well-known manner. The scanner is a laser-based barcode scanner containing an embedded display, microcontroller and programmed user interface. A button activates the laser scan of the barcode tag. Communications with the network is provided by an IEEE 802,11b or g radio interface and a complementary wireless access point 1016 with suitable firewall 1018 connected to the network. The scanner is preferably powered by rechargeable batteries.

A third user interface 1020 for use by shop floor managers or other management presents reports based on the stored occurrence data. A time/date period and selection of report type may be provided by third user interface 1020 in order to generate a custom report of a particular type.

A fourth user interface 1022 on central server 1024 for use by clerical or clerical management staff of the application service provider receives bill of material data, and the standard price/cost information used for comparison with the event occurrence data to generate variance reports and gross margin for viewing on third user interface 1020.

Each of the interfaces on respective PCs is browser-based. That is, each interface is based on an HTTP client running over a secure socket layer connection.

When central server 1024 receives the event identifier from second user interface 1014, a software application is triggered to determine from the event tracking database whether the event identifier is a raw material identifier or a finished goods identifier based on the expected event data with which it is associated. The software application then determines the first of the expected events in the sequence that has not previously occurred, and stores a flag in association with it to indicate that it has occurred. The flag constitutes stored occurrence data. The software application stores the date and time either as the flag or in association with the flag.

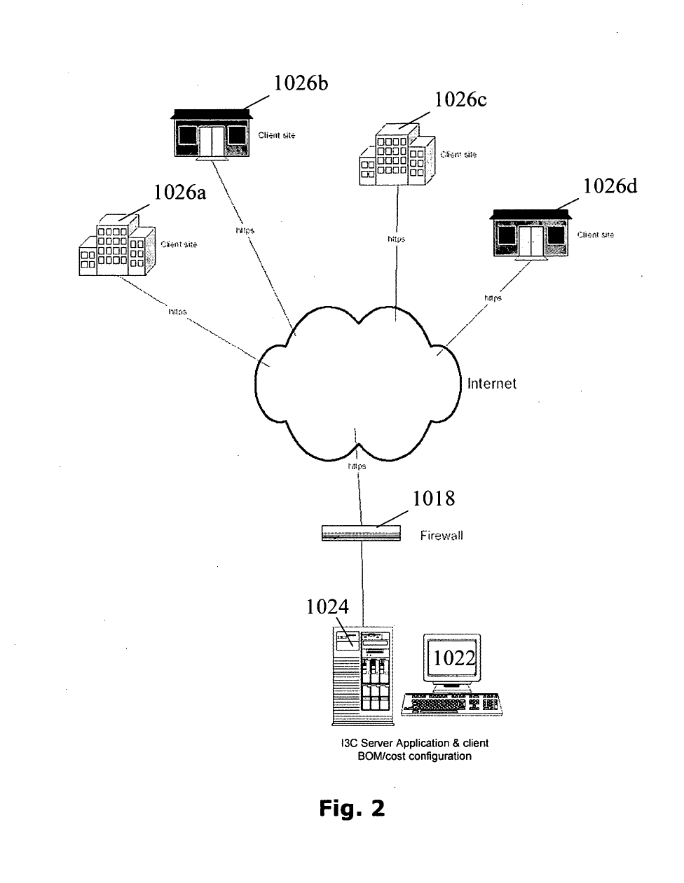

FIG. 2 is a network topology diagram showing a multi-client system integrating several single-client interfaces shown in FIG. 1. Central server 1024 is in communications via the Internet or a WAN with several production companies' event tracking interfaces 1026a-d. Central server 1024 is connected to the several production companies' event tracking interfaces 1026a-d via the Internet, protected by firewall/gateway/router 1018. The data relating to each of the several production companies is kept separate on central server 1024 and accessible only to those having appropriate permission (i.e. user names and passwords) in a manner well-known to those familiar with web-hosting technologies and techniques. Central server 1024 also includes a local, browser-based interface 1022 for configuration functions, some of which functions may be accessible from one or more of the browser-based interfaces at the production companies' respective sites.

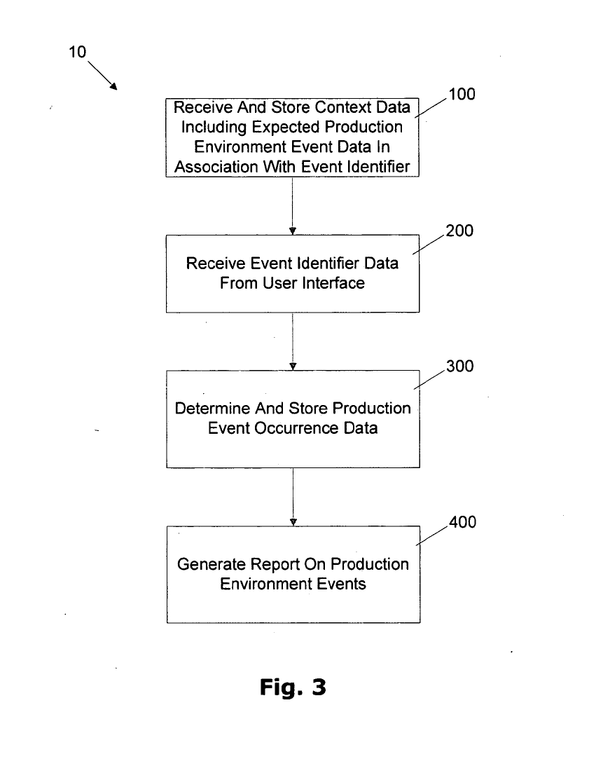

Turning to FIG. 3, a flow diagram of a method of event tracking using system 1000 in a production or plant environment is shown and is generally identified by reference numeral 10. According to this embodiment, the events being tracked relate to the movement of raw materials into the plant, the issue (or “draw”) of materials into the production process, the completion of subassemblies and finished goods, and the shipment of the goods out of the plant.

During the method, context data including expected production environment event data is received and stored in association with an event identifier (step 100). In order to develop the strategy for production event tracking in a particular production environment, first identified are the events of interest (i.e. the expected events) that represent the particular activities in the production environment whose occurrence will suitably track the production process. Once the expected events are identified, the clerical and management tasks required to determine the context of the expected events at any time during the production process are identified. The identified clerical and management tasks are then used to create the types and format of inputs into the system for storing the identified expected events (i.e., the forms required to be completed by the clerical staff). Means are provided for automatically associating each of at least one event identifier with a respective plurality of expected events once entered as inputs by the clerical staff, and for determining the system state so that when an event identifier is received at a particular date/time from a user interface as will be described, occurrence of a particular one of the expected events can be determined.

While the expected events are unique, the event identifier itself may be associated with several expected events to significantly reduce the complexity of a production worker's user interface, as will be described. During production, event identifier data is received in real-time from a user interface (step 200) to signal occurrence of an expected production environment event. Production event occurrence data is then determined and stored (step 300), and a report on the production environment events is generated (step 400).

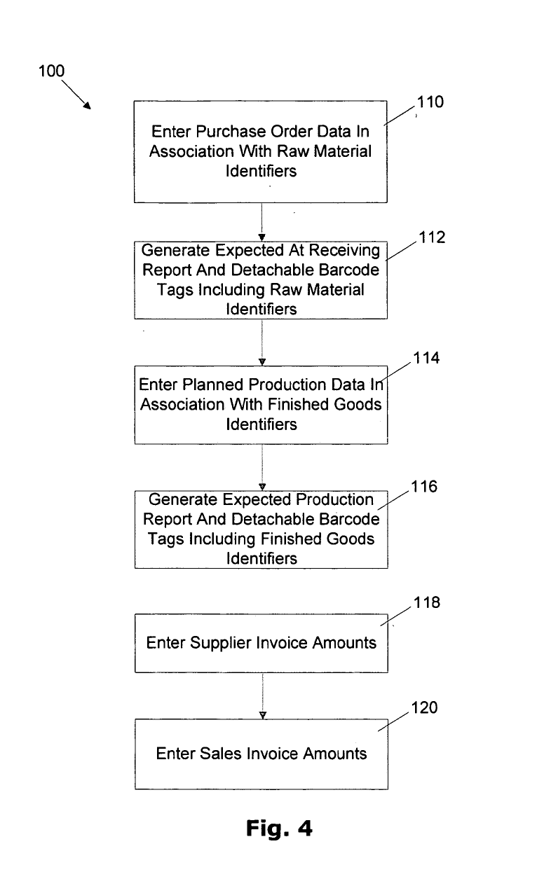

FIG. 4 is a flow diagram of the receipt and storage of production context data (step 100). Whenever a raw materials purchase order is created, the purchase order data is input into central server 1024 by plant clerical staff via a first user interface. The purchase order data represents the expected events of raw material delivery and raw material issue (i.e., draw). These expected events are then electronically stored in association with a respective raw material identifier (step 110). In other words, both the expected unique events of raw material delivery and raw material issue are associated in a database with the raw material identifier. It will be understood that, according to this embodiment, raw material delivery and issue for a first material will be associated with a different raw material identifier than expected events respecting a second material.

An Expected At Receiving Report is then automatically generated which includes detachable barcode tags corresponding to each expected raw material to be delivered (step 112). The plant's purchasing process is therefore modified to allow the central server 1024 to be informed directly of which raw materials are expected to be delivered, and in what quantities.

Next, via the first user interface, the plant clerical staff enters planned production data corresponding to customer orders being processed that represent the expected events of finished goods completion with quantities and finished goods shipping. These expected events are stored in association with a respective finished goods identifier (step 114). An Expected Production Report is then automatically generated which includes detachable barcode tags corresponding to each expected shipping unit of finished goods to be completed (step 116).

In order to track raw materials price variances for subsequent reporting, supplier invoice amounts for raw materials are entered (step 118). In order to track sales price variances for subsequent reporting, sales invoice amounts for finished goods are entered (step 120).

The barcode tags from the Expected At Receiving Report and the Expected Production Report are then affixed to respective ones of the raw materials as they are delivered and the finished goods as they are produced, by sticking the tags on the items or their containers.

It will be understood that unique barcode tags will have been generated and expected events will have been stored at a time when the expected events are first contemplated by the clerical staff of the plant. For example, unique barcode tags are generated for each line item of raw material expected to be delivered whenever a raw materials purchase order is created. Similarly, unique barcode tags are generated for each shipping unit of finished goods whenever a customer order is processed.

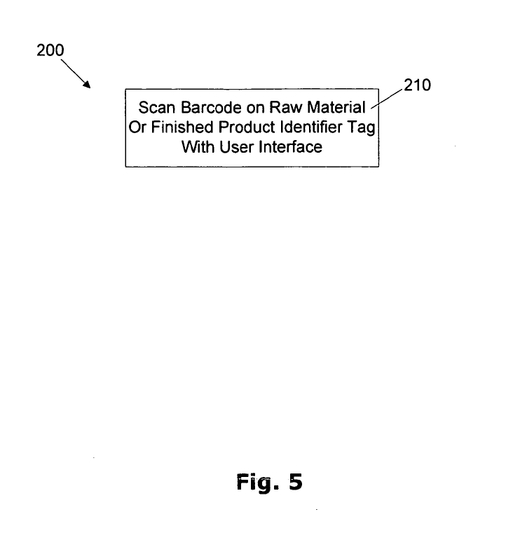

FIG. 5 is a flow diagram of the inference of the occurrence of unique events upon receipt of event identifiers from a user interface to signal occurrence of an expected event. A production worker at any point in the production process uses a scanner of a second user interface to scan the unique barcode tags on either the raw material or the finished goods to which the tags are affixed in order to signal occurrence of an expected event (step 210). Once this has been done, the production worker's data entry requirement is complete, since the system has been “preloaded” by the clerical staff with all data required to report on the event. In other words, the occurrence of the event has been given context prior to its occurrence, such that the production worker need merely signal occurrence of the event via the second user interface, and does not have to enter any further details.

In particular, when a shipment of raw material is delivered, its corresponding unique barcode tag is removed from the Expected At Receiving Report and affixed to the raw material (or its container). The production worker, using the scanner of the second user interface, then scans the unique barcode tag to signal delivery of the raw material.

When a shipping unit of finished goods has been completed, its corresponding unique barcode tag is removed from the Expected Production Report and affixed to the finished goods (or its container). The same or another production worker, using the scanner of the second user interface (which in some production environments may be another user interface device with the exact same second user interface as that used in the receiving example mentioned above), then scans the unique barcode tag to signal completion of the finished goods.

It can be seen that because detailed information on the set of expected events has been stored, recording the actual occurrence of the events is much simpler than in existing MRP/ERP systems. The occurrence of data errors by production personnel and the training requirements are therefore drastically reduced.

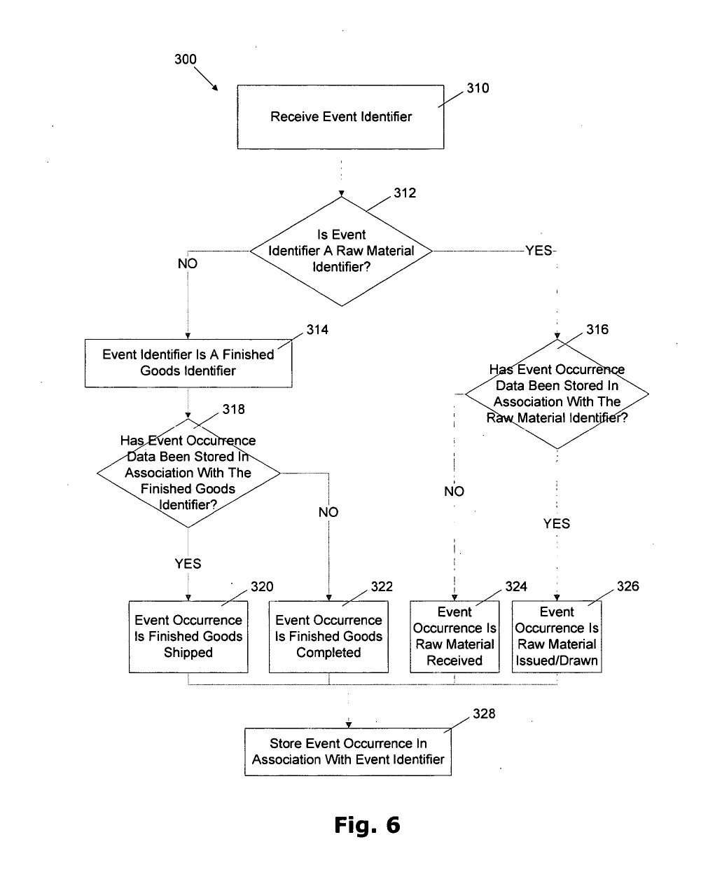

FIG. 6 is a flow diagram of the determination and storage of production event occurrence data. When a production event identifier has been received (step 310), it is determined from the associated expected production event data whether the production event identifier is associated with a raw material expected event or a finished goods expected event (step 312). If the production event identifier is not a raw material identifier, it is deemed to be a finished goods identifier (step 314). In this case, it is determined whether production event occurrence data has previously been stored in association with the finished goods identifier (step 318). If so, then the finished goods completion event has already occurred and the receipt of the finished goods identifier is considered to signal occurrence of shipping of the finished goods (step 320). Otherwise, receipt of the finished goods identifier is considered to signal occurrence of completion of the finished goods (step 322).

At step 312, in the event that the production event identifier is a raw material identifier, it is determined whether production event occurrence data has previously been stored in association with the raw material identifier (step 316). If so, then the raw materials delivery has already occurred and the receipt of the raw material identifier is considered to signal occurrence of the issue or draw of the raw materials for use in producing a shipping unit of finished goods (step 326). Otherwise, receipt of the raw material identifier is considered to signal occurrence of delivery of the raw material (step 324). Once it has been determined whether raw material has been delivered or issued, or finished goods have been completed or shipped as detailed above, production event occurrence data representing the determined occurrence is stored in association with the event identifier (one of the raw materials identifier and the finished goods identifier) (step 328). Date/time information is also stored for use in generating time/date-relevant reports as will be described below.

It can be seen from the above that the combination of a system state and receipt of the event identifier signals occurrence of one of the unique events. The production worker entering the event identifier does not have to specify which unique event, associated with the event identifier, has occurred. The unique event is then determined automatically from the system state. For example, a first system state may be wholly or partly defined as “waiting for delivery of first raw material” and is the system state where the event identifier associated with the expected event of delivery of the first raw material has not previously been received. This state is determined according to this embodiment by checking whether event occurrence data has previously been stored in association with the associated event identifier. Upon receipt of the associated event identifier from the user interface, the expected unique event of delivery of the first raw material is deemed to have occurred because at the time of receipt of the associated event identifier, the system state respecting that event identifier is “waiting for first raw material delivery”. Event occurrence data is then stored so the system state respecting that event identifier, either explicitly or implicitly, is changed to “waiting for draw of first raw material”.

A subsequent receipt of the event identifier in combination with the system state of “waiting for draw of first raw material” for the event identifier signals occurrence of the expected event of draw of the first raw material because at the time of the subsequent receipt of the event identifier the system state respecting that event identifier is “waiting for draw of first raw material”. Event occurrence data is then stored so the system state respecting that event identifier, either explicitly or implicitly, is changed to “first raw material drawn”.

Similarly, the system state is changed from “waiting for production of first finished good” to “first finished good produced” upon receipt of the associated finished goods identifier from the user interface, then to “first finished good shipped” upon second receipt of the associated finished goods identifier from the user interface.

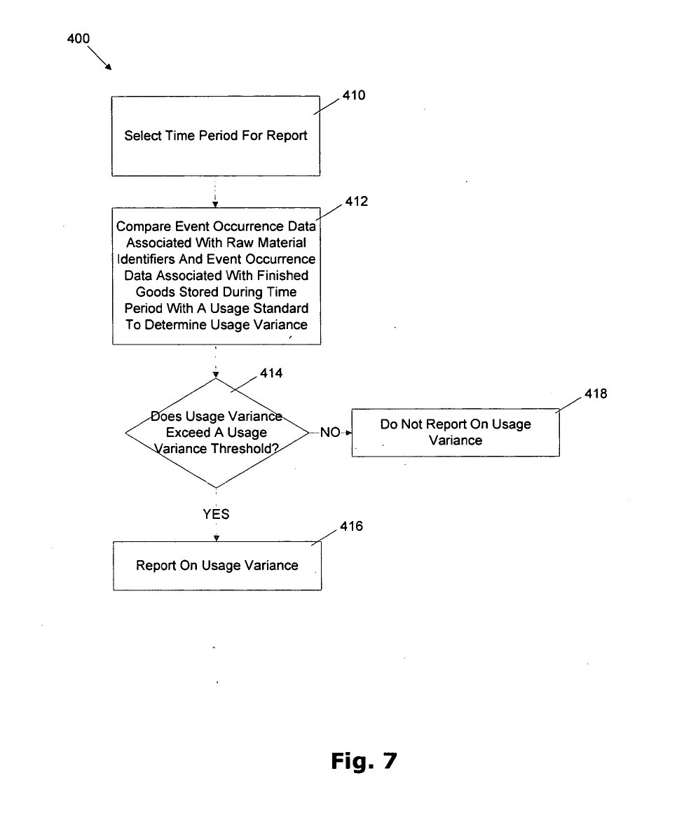

FIG. 7 is a flow diagram of the generation of a materials usage report (step 400). A time period is selected for the report by a user such as a shop floor manager via a third user interface (step 410). Generation of the report includes comparing the event occurrence data associated with the raw materials identifiers and event occurrence data associated with the finished goods identifiers, that have been stored during the selected time period, with a preselected usage standard. The comparison determines a usage variance (step 412). The usage variance is then compared to a preselected usage variance threshold (step 414) and in the event that the usage variance threshold is exceeded, the usage variance is reported using the event occurrence data (step 416). The shop floor manager is thereby immediately able to view details of a variance outside of an acceptable range and begin to query shop floor personnel about the variance in order to account for it and, where appropriate, make corrections. For example, should the quantity of raw material used to produce a particular quantity of finished goods be greater than an acceptable amount (by having caused a variance that exceeds the threshold), the manager may immediately be alerted and seek information from the shop floor personnel as to why this has occurred. Corrections may be made as necessary in order to efficiently keep production optimized.

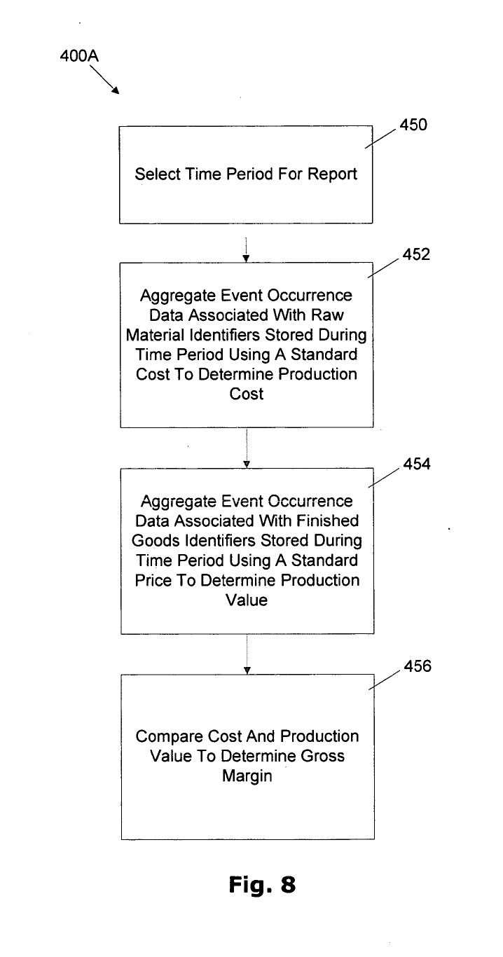

FIG. 8 is a flow diagram of the generation of a gross margin report (step 400A). A time period is selected for the report by a user such as a shop floor manager via a third user interface (step 450). Generation of the report includes aggregating event occurrence data associated with raw material identifiers stored during the selected time period using a pre-selected standard cost, in order to determine a total production cost for the period (step 452). Event occurrence data associated with finished goods identifiers stored during the selected time period are then aggregated using a standard price to determine the value of goods produced (step 454). The production cost and production value are then compared in order to compute a gross margin for reporting (step 456).

It will be understood that in addition to tracking expected production events including delivery and issue of raw material and completion and shipping of finished goods, that production events such as the start and completion of direct labor by a production worker may be tracked. For example, a production worker's unique ID tag may be read via the second user interface (having an automated reader) when the worker enters the production area, at or near the time of a shift start, then again when the worker leaves the production area at or near the time of a shift end. Start work and stop work events are thereby recorded for computation of the direct labor undertaken during production. This direct labor data may be used to compute labor variances and gross margin in a similar manner as has been described above. In this case, the event identifier is the worker's unique ID, and the system state required to distinguish the event from all others in the set of expected events is the time at which the ID was received, and the production schedule.

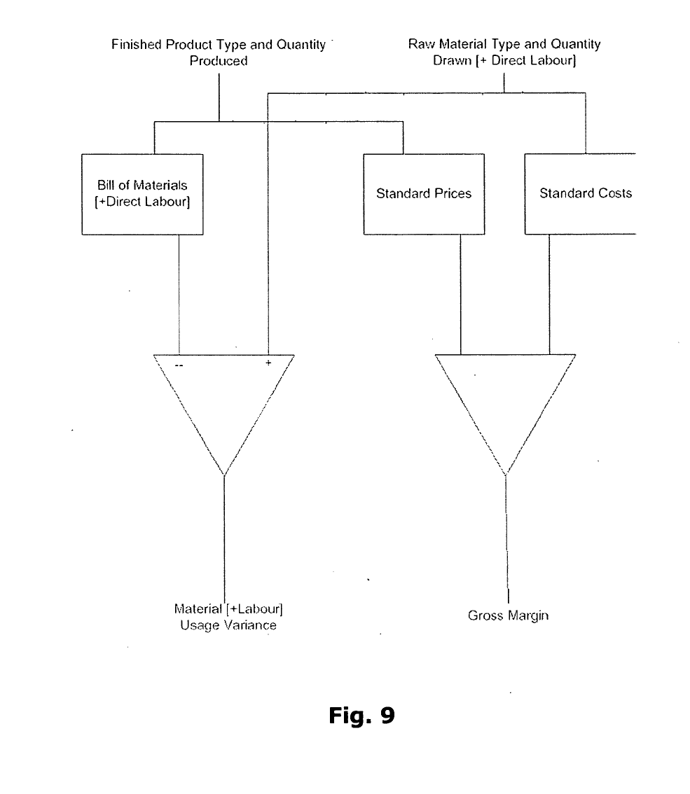

FIG. 9 is a data flow diagram showing finished goods and raw material event occurrence data and predetermined standards used to calculate the materials usage and gross margin reports. The finished goods data, the raw materials data, and optionally the labor usage data described above are used with the stored expected production event data from the bill of materials, standard prices and standard costs to compute material and labor variances and gross margin.

Although particular embodiments have been described in detail, it will be understood that variations and modifications may become apparent to the skilled worker based on the above.

For example, while the inferential scanner described above has been characterized as a laser-based (optical) scanner, it will be understood that other means of obtaining an event identifier such as a raw material identifier or a finished goods identifier may be employed. For example, a radio frequency transceiver may be employed for entering the event identifier by bringing the radio frequency transceiver into proximity with a radio frequency identification (RFID) tag on raw material or finished goods.

In the embodiments described above only a production event identifier has been shown to be received by the user interface in the production environment. This illustrates the extremely simple nature of the user interface as appropriate in a very large number of circumstances. For example, in discrete production environments such as assembly of personal computers, it is possible to define the context data such that mere receipt of an event identifier signals occurrence of delivery of a particular quantity of raw material or a particular item (such as a discrete component like a hard drive). However, in other implementations, event parameters such as raw material quantity may be received from the second user interface at or near the same time the event identifier is received. It will be understood that while such event parameters are not required to signal occurrence of an expected event, their provision by the second user interface can provide additional information useful for reporting and the like.

While the above has been described with reference to a production environment, it will be understood that the principles disclosed herein may be employed in other environments. For example, in a medication delivery environment, expected event data such as medication delivery data representing expected prescription filling, delivery and administration to patients may be pre-loaded as the context data. The medication delivery data includes patient identifiers, medication, doses, dose intervals and a medical carrier bin identifier.

The originator of the medication delivery data is an attending physician, and loading of the context data respecting expected prescription filling and prescription delivery is done typically at the time of the physician's ward rounds. To load each prescription into the system, the physician or an authorized proxy scans a unique patient ID from the patient or his/her chart, and selects medication from a dropdown list in the user interface of enabled medications for the patient. A dose is then selected from acceptable doses for the patient, of the selected medication. A dose interval is then selected from acceptable intervals for the patient/medication/dose combination. Lastly, a dose starting time is selected from a list of available ward medication round times.

The system programs unique RFID (radio frequency identification) tags incorporating medication carrier bin identifiers for affixing (or, if they are reprogrammable, already affixed) to respective medication carrier bins in which the medication, dose etc. information for the next ward medication round is to be placed. The bin identifiers are changed with each use of a carrier bin, in order to identify uniquely the associated prescription information. These identifiers and the associated patient, prescription and delivery time information are analogous to the “Expected Production” report in the production environment.

During operation, medication is drawn from the hospital pharmacy by a pharmacist or assistant with the guidance of the stored medication delivery data accessed via a GUI front end to the stored prescription filling information. During this procedure, the pharmacist uses a simple user interface such as an inferential scanner to scan a medication carrier bin identifier. In response to the medical carrier bin identifier being received, the stored medication delivery data corresponding to the associated prescription, patient and medication delivery event is displayed on the GUI. The pharmacist then draws the medication required to fill the prescription from the pharmacy's stock, in a manner analogous to the draw of raw materials in a production environment. It is to be understood that checks and balances can be programmed at this point to ensure that an appropriate type and quantity of medication is drawn to fill the currently active prescription, and that an alert may be programmed to inform the pharmacist of any inconsistency in the procedure of filling the current prescription. Upon opening the medication carrier bin to insert the required medication, the user interface including a radio frequency receiver automatically receives the medication carrier bin identifier transmitted by the unique RFID tag thereby signaling the occurrence of the expected event of filling of the prescription by the pharmacist. It will be understood that the act of opening and then closing the medication carrier bin or other such action could cause the transmission of the medical carrier bin identifier to signal the occurrence of the expected event of filling the prescription. It will also be understood that checks and balances may be programmed into the operation of the system. For example, should the pharmacist open a medical carrier bin causing transmission of a medical carrier bin identifier that is not part of the current, expected set of prescriptions, an alert can be generated for the pharmacist so as to greatly reduce the chance that the wrong medication be allocated to a patient. It can be seen that with the above and variations thereof, matching the patient with the appropriate medication is greatly simplified for the pharmacist. Errors are therefore greatly reduced, and training simplified.

In order to provide further functionality to a medication delivery environment, there may be one-time programmable RFID tags in the patient wrist band, encoding the patient identifier, a copy of which is also available as the chart identifier. Furthermore, there may be a nurse identifier card encoding a unique nurse identifier, which is transmitted automatically along with the medication carrier bin identifier, when the nurse opens the lid of the medication carrier bin. There may also be a doctor/proxy identification card to authenticate and record initial prescription entries without requiring repeated entry of this information into the system.

During ward medication rounds, the nurse simply scans the patient identifier on the patient or on the chart using a user interface such as an inferential scanner. A software application on the central server is triggered to, upon receipt of the patient identifier from the inferential scanner, retrieve the medication carrier bin identifier associated with the patient identifier as context data. The software application then broadcasts a query (by causing the inferential scanner to broadcast the query using Bluetooth short range wireless transmission, for example) to medication carrier bins on the nurse's cart with the retrieved medication carrier bin identifier. The medication carrier bin identified by the broadcasted medication carrier bin identifier responds with an audible and visible signal. The nurse then opens the medication carrier bin and the nurse's ID tag is then triggered to transmit to the inferential scanner the nurse's unique ID for subsequent provision to the central server. The nurse then administers the medication from the medication carrier bin. Meanwhile, the central server receives the nurse's identification and records the occurrence of the expected medication delivery event using the expected event data including patient identifier, dose uptake, and the unique ID of the administering nurse, without requiring further human actions. The nurse's interaction with the system is therefore limited to scanning a wrist tag having the patient identifier, and picking medication out of the medication carrier bin that is actively beeping and flashing.

It can be seen from the above description that, according to this embodiment, additional event parameters are not required to be entered by the users. Existing medication tracking and delivery systems in some cases make use of bar-coding or other identification technologies, and require nursing staff to operate more traditional computer interfaces as part of the medication delivery operation. The embodiment described above offers distinct and significant advantages over existing systems due to its sheer simplicity of use.

Another example of an environment in which the principles described herein may be applicable is that of a sporting match. Typically, in a sporting league (such as a soccer league), after each game, a league office employee or volunteer must collect paper forms from each game, enter the data from the forms including scoring player information (player identifiers) and the sporting match outcome. The data entry is done via a traditional graphical user interface, and the league database web page may be updated accordingly.

According to an embodiment applicable to the sporting match or league environment, at the beginning of the season, a league administrator associates in a central server database a unique player identifier on a tag affixed to each player's jersey label with the individual player (name etc.), and the game schedule is entered into or created automatically by a software application on the central server in a similar manner as has been described above with reference to other embodiments.

On each goal, the referee/scorekeeper scans the scoring player's jersey label with an inferential scanner. The unique player identifier is received by the central server, which triggers a software application to retrieve the current game score, update the score including the date/time of the goal in association with the player identifier. The central server then returns to the inferential scanner a display of the updated game score for confirmation. An “undo” function is available to the scorekeeper in case of an incorrect scan. This is all that is required of a human for interaction with the system for the duration of the season.

The date/time stamp of the scan stored as part of the occurrence data plus the player identifiers may be automatically compiled to produce a report of game results and individual scoring statistics. The league database or website may thereby be updated automatically, in real-time.

In this case, event parameters are not required to be entered by the scorekeeper, greatly simplifying the use of the system.

Although embodiments have been described, those of skill in the art will appreciate that variations and modifications may be made without departing from the spirit and scope thereof as defined by the appended claims.

What is claimed is:

1. A system and method of event tracking for manufacturers, which exploits some or all of the known relationships between:
a. purchase orders and receipt of quantities of the factors of production by a manufacturer;
b. the combination of work orders and bills of materials and the draw of quantities of the factors of production onto the production floor;
c. work orders and completion of quantities of finished goods as output from the production floor; and
d. sales orders and the shipment of finished goods from the manufacturer wherein:
i. purchase orders are used to determine the set of RFID tags required to be affixed to quantities of the factors of production received by the manufacturer;
ii. usage of specific quantities of the factors of production is recorded by the detection of the RFID tags of the factors during their passage from raw materials stores to the production floor;
iii. work orders are used to determine the set of RFID tags to be affixed to quantities of the finished goods;
iv. completion of finished goods is recorded by the detection of the RFID tags of the finished goods during their passage from the production floor to finished goods stores;
v. shipment or customer pickup of finished goods is recorded by the detection of the RFID tags of the finished goods leaving the manufacturer;
vi. detected quantities of the factors of production used to create recorded finished goods during a given production period are compared with expected quantities for factors of production inferred to be required from the bills of materials of the finished goods, to generate reports on the production processes;
the system comprising networked computer(s) and RFID tag programmer(s)/reader(s), with reading antennas situated between raw materials stores and the production floor; between the production floor and finished goods stores; and at an exit from the manufacturer.

2. The system and method of claim 1, omitting item vi.

3. The system and method of claim 1, omitting item v. and the associated components of the system.

4. The system and method of claim 1, omitting item v. and the associated components of the system, and omitting item vi.

5. The system and method of claim 1, omitting items iii., iv., and v. and the associated components of the system, and omitting item vi.
